(19) United States
(12) Patent Application Publication
(10) Pub. No.: US 2025/0083361 A1
(43) Pub. Date: Mar. 13, 2025

(54) Improved method and system for reclaiming the individual components of a synthetic or artificial turf product

(71) Applicant: Re-Match Holding A/S, Herning (DK)

(72) Inventors: Martin WELLING, Herning (DK); Rasmus D. DAMHUS, Herning (DK)

(73) Assignee: Re-Match Holding A/S, Herning (DK)

(21) Appl. No.: 18/726,643

(22) PCT Filed: Jan. 6, 2023
(86) PCT No.: PCT/EP2023/050214

§ 371 Date: Jul. 3, 2024

(30) Foreign Application Priority Data
Jan. 6, 2022 (EP) 22150418.6

(51) Int. Cl. B29B 17/02; B29B 17/00; B29B 17/04

(52) U.S. Cl. CPC B29B 17/02; B29B 17/04; B29B 2017/0021; B29B 2017/0224; B29B 2017/0234; B29B 2017/0241

(57) ABSTRACT

The present invention relates to an improved method and system for reclaiming the individual components of a synthetic or artificial turf product in a form almost similar to their original outset. The result is achieved by a method divided in three sections a first section in which the turf is downsized and dried, a second section where infill, such as rubber and sand, is separated and a third section where grass fiber and backing are separated.

### CROSS REFERENCE TO RELATED APPLICATIONS

The instant application is a U.S. National Stage Application of and claims priority to PCT/EP2023/050214, filed on Jan. 6, 2023, which is a PCT application of and claims priority to EP 22150418.6, filed on Jan. 6, 2022, the subject matter of each of the aforementioned applications are hereby incorporated by reference in their entireties.

### TECHNICAL FIELD

The present invention relates to an improved method for reclaiming the individual components of a synthetic or artificial turf product in a form almost similar to their original outset. The result is achieved by a method divided in three sections a first section in which the turf is downsized and dried, a second section where infill, such as rubber and sand, is separated and a third section where grass fiber and backing are separated.

### BACKGROUND

Synthetic turf has been used for many years as surfaces for football, baseball and soccer fields. In the recent years it has been used in other applications where an alternative to natural grass is desired. These applications include at least playgrounds, residential and commercial lawns and other landscaping, paths, paintball fields, tennis courts, putting greens, dog runs etc.

Typically, synthetic turf includes a grass-like fabric having a backing and a plurality of upstanding ribbons, also called face fibers, resembling grass. Many synthetic turf products also include an infill material dispersed among the upstanding ribbons, which may consist of sand, tire rubber crumb, or other particulates, either singularly or in combination with each other. The infill material simulates the soil in natural turf, acts as a ballast, and/or contributes to the physical properties of the turf, such as resiliency, that makes the turf suitable for a particular use.

Synthetic turf has a limited life span, depending on the construction of the turf, the application for which it is used, weathering and how the turf is maintained.

As an example, a typical synthetic turf for use as an athletic field may have a useful life of from about 8 to 15 years. A large amount of synthetic turf is currently being used in hundreds of athletic fields and in other applications.

Disposing of the turf is very expensive due to the composition of materials ranging from recycled rubber, sand to plastic. To avoid sending the turf to landfills at a substantial cost, recycling and reusing all or portions of the synthetic turf has been an explored option over recent years.

Methods for recycling carpets and for preparing carpet backing using recycled carpet scrap are known. Some of such methods involve separating the carpet yarns, or tufts, from the backing, e.g. by cutting, and processing only yarns.

However, synthetic turf differs in composition from carpet, and those differences in composition make conventional carpet recycling processes unsuitable for recycling synthetic turf. The majority of carpet products use nylon face fibers, while the majority of current synthetic turf products use polyethylene.

The primary coating of most carpets is a latex coating, while the coating in most synthetic turf is polyurethane. In the United States, only a small fraction of broadloom carpet includes a coating containing polyurethane, and only a small fraction of synthetic turfs has a coating containing latex. Most of the synthetic turf manufactured in the past 6 years has had a polyurethane coating applied to the backing. There is a belief that polyurethane coated synthetic turf, as a whole, cannot be recycled. This is because the polyurethane coating, cannot be efficiently recycled. Polyurethane is thermoset (versus thermoplastic) and is therefore difficult and costly to recycle. Notwithstanding, recovery of polyurethane from carpets is described in U.S. Pat. No. 5,185,380 where the backing is scraped off, comminuted, subjected to a cyclone classification step to remove hard foreign constituents, such as metals and PVC, and the non-hard constituents are consolidated under elevated pressure and temperature to provide sheets. This method thus provides a new product from parts of the used carpet.

In turf, the coating is applied to the backing of a tufted material for the purpose of locking the face fibers into the primary backing. An additional coating of a hot melt adhesive or a polyurethane foam can also be applied. This secondary coating is typically used to attach a secondary backing which can be polyester or polypropylene.

Many synthetic turf products include components that are not found in carpet and that are incompatible with, or at least undesirable in, conventional carpet recycling methods. For example, conventional carpet does not include infill. Typical infill materials for synthetic turf installations include sand, tire rubber crumb, and/or other particulates, either singularly or in combination with each other. Thus, recycling synthetic turf presents a unique problem not encountered in the recycling of carpet.

Separating infill from the remainder of the turf may require use of special equipment, and there may be environmental concerns associated with disposing of the separated infill. Additional concerns in the recycling process are the effect of any residual infill particulates on the size reduction process and on the properties of the final product.

Thus, attempts have been made to recycle and reusing an existing synthetic turf, or at least a portion of an existing synthetic turf, to avoid sending the entire synthetic turf to a landfill when it is no longer useful. Such a process is described in WO 2010/075098 in which infill is separated from the backing and the grass like fibers followed by downsizing and further removal of infill followed by agglomeration. The granules of agglomerated turf fragments are placed into an extruder. The granules are extruded to form an extrudate, for example in the shape of a strand or ribbon. Most known processes consequently recycle the constituents of carpets or turfs to new products of mixed components and do not reverse engineer the products into the individual starting components.

EP 2 096 211 describes another method for disposing of synthetic grass comprising in which grass fiber and backing are first separated from infill and additional components and then subsequently separated in a large number of steps. Hence, existing processes can separate the materials to a purity of 95% only which is satisfactory when for example the process is for extruding/consolidating for providing new products. Thus, while the prior art processes are an improvement over disposing the material at the land fill, there is still a need to separate the individual parts further, into fractions substantially comprising one component in order to provide improved grade products.

It is also desirable to provide processes that are flexible so that the composition of the turf and the infill may vary.

It is also desirable to provide processes in which the result is the individual components purified to a degree that is high enough for reuse as turf or in other industries.

EP 2 862 688 granted to the same applicant deals with a dry separation process where the individual components are provided essentially pure—The method comprises three specific separation steps in a specific order hence the separation is based on size, specific gravity and specific gravity, size and shape. Usually when the turf product originates from an athletic field, rubber and/or sand is used as infill. While a large proportion of the sand and rubber may easily separate from the remaining part of the turf product, substantial amounts of sand and rubber are still present within the structure. In particular, sand, dirt, or gravel must be removed from the polymeric components in order to improve their usability in the same (i.e. artificial turf) or other types of products. Being able to provide the rubber fraction essentially pure also free of sand and/or gravel is necessary for reuse thereof in the same application. The separation of fine particles, such as sands, has proven to be a particularly challenging task. Also, efficiency of the process continues to be a focus area in order to obtain a cost-effective process that will continue to outperform traditional landfilling and incineration as an alternative.

Therefore, it is an object of the invention to further improve the process of separating the individual components in an effective manner and more specifically doing so by i.e. making the infill separation more efficient and capable of providing individual fractions of size and quality for improved reuse.

### SUMMARY OF THE INVENTION

In a first aspect these and further objects are solved by a method for processing a synthetic turf product and for recovering components thereof, said method comprising a feeding and a downsizing section, an infill separation section and a turf and backing separation section, said feeding and downsizing section is in fluid communication with the infill separation section and the turf and backing separation section, and wherein the feeding and downsizing section comprises the following steps:
(a) feeding a moist artificial turf product to the feeding and downsizing section,
(b) downsizing the moist artificial synthetic turf product into a downsized turf material, preferably to no more than 120 by 120 mm, and feeding the downsized turf material to a drying unit,
(c) drying the downsized turf material in the drying unit, for example in a drum drier, to a moisture content of no more than 5% w/w, preferably no more than 3% w/w, most preferably no more than 1% w/w, to a dried material,
(d) separating the dried material by screening in a first sieving unit, 103, into at least a first fraction substantially comprising an infill material which is fed to the infill separation section and a second fraction substantially comprising grass fiber and backing components,
(e) downsizing the second fraction substantially comprising grass fiber and backing components to at most 50 mm in the largest dimension in a downsizing unit and optionally feeding the further downsized fraction to a first screening unit, such as a drum screen having openings of 4 to 8 mm, preferably, 6 mm, to provide a small fraction and a large fraction,
(f) feeding the further downsized fraction (5) or if not optional, the large fraction obtained in step (e) to a material hopper continuously supplying the fraction, optionally downsized further to at most 35 mm in the largest dimension, to the turf and backing separation section; and
(g) further processing the first fraction obtained in step (d) and the small fraction, if present, obtained in step (e) in the infill separation section.

The drying air temperature of step (c) at the entry of the drying unit suitably has a temperature in the range of 125 to 250° C., preferably 150 to 230° C., the length of the drying unit is 8 to 15 m, preferably 10 to 12 m, and the downsized turf material is fed at a range of 6 to 10 tonnes per hour, preferably 8 tonnes/hour on a dry basis.

It is preferred that the components during the drying are not melted or agglomerated as this will deteriorate the quality of the end fractions. Hence, temperature, time and size of the components are important factors of the optimal drying that will enable the subsequent separation. Size is important since the feed to be dried is composed of sand and rubber but also the carpet which must be dry too to released integrated infill but without melting. Typically, the components of the carpet have the lowest melting temperature.

When the drying unit is a drum dryer, it is operated at a speed of 1200 to 1600 rpm, preferably 1400 rpm.

Once the feed has been suitably prepared by downsizing, drying and initial separation, it is possible in the subsequent sections to separate the distinct components to the required high purity and at a sufficient high yield to enable a cost-efficient process.

The infill separation section comprises the following steps:
i) feeding the first fraction obtained in step d) and the small fraction obtained in step e) to a main sieving unit having three sieving means, a first sieving means, a second sieving means having openings of 0.5 to 1.5 mm, and a third sieving means having openings of 0.1 to 6 mm, wherein the first sieving means is a grate type sieving means having perforations wherein the longest dimension of the perforations is 3 to 6 mm, thereby providing four fractions, an upper fraction, a first and second intermediate fraction and a lower fraction, wherein the first intermediate fraction is further processed for rubber recovery and the second intermediate fraction is further processed for sand recovery.

The main sieving step separates most of the sand from the rest of the components. Sand is by weight the largest component of the turf product. The first sieving means further separates rubber from backing and turf. Hence, this step will enable the more difficult task of being able to provide pure rubber.

Another challenge in recovering components of turf products is to be able to separate the components at a speed and volume over the sieving area available. Hence, in an embodiment one or more of the sieving means is provided with at least one baffle, preferably on the upper sieving means, such as the first sieving means. It is also contemplated that baffles are present on sieving means in other sieving units in addition to the main sieving unit.

The baffles will help the feed distribute over the whole are of the sieving means thereby improving the sieving capacity over the time the feed is transported through the various sieving means. It is preferred that the at least one baffle is positioned at an angle (a) in the range of 30 to 60°, preferably, 40 to 50°, such as 45° in relation to a horizontal plane of the sieving means, and that the at least one baffle is attached in the middle section of the sieving means, preferably on a horizontal line between ¼ and ¾ of the length of the sieving means.

As the feed moves across the sieving means from the inlet to the outlet the natural movement of the flow will result in the material moving towards the edges of the sieving means. However, when baffles are placed at the specified angle in the specified area of the sieving means, the feed will be evenly distributed over the whole area thereby improving the overall separation.

It is contemplated that each sieving means has two or more baffles, such as 2, 3, 4 or 5 baffles. The number of baffles may be determined based on the area of the sieving means. Thus, the number of baffles needed for optimal separation increases with the area of the sieving means.

After the main sieving step, the first intermediate fraction is further processed for rubber recovery by the steps of
ii) feeding the first intermediate fraction to a second sieving unit having three sieving means, a first sieving means having openings of 1.2 to 3.5 mm, a second sieving means having openings of 0.8 to 2.5 mm, and a third sieving means having openings of 0.5 to 2.0 mm, thereby providing four fractions;
iii) feeding each of the four fractions obtained from the second sieving unit to a first set of four individual separating means, said means separating by specific gravity using air, to provide four low-density fractions comprising backing material and rubber and a combined high-density fraction comprising additional components, such as stones; in this first rubber recovery step, heavy material such as stones are separated from the mixed fraction. This will enable the more sophisticated separation of rubber from other materials. The stones, if free of rubber, can be reused and sold.
iv) feeding each of the four low density fractions to a second set of four individual separating means, said means separating by specific gravity using air, to provide a combined low-density fraction comprising backing material and a second combined high-density fraction comprising rubber, and further wherein the second combined high-density fraction comprising rubber is recovered or further processed in a rubber polishing unit; in this second rubber recovery step, the rubber now being the heavy fraction is separated from a mixed fraction comprising backing material. This will allow a further refined processing of the rubber into distinct rubber fractions of different size.

The combined low-density fraction comprising backing material is further subjected to the steps of
v) separating by specific gravity and size by providing an airflow directed upwards in a separator configured to cause a swirling motion whereby a lighter fraction is entrained upwards in the air flow and a heavy fraction is allowed to fall downwards; where the lighter fraction comprises backing material, and the heavy fraction comprises additional material, such as stones, the stone fraction may be mixed with the heavy fraction obtained in step v; in step vi) the lighter fraction comprising backing material is subjected to a third sieving step in a third sieving unit having two sieving means, a first sieving means having openings of 2 to 5 mm and a second sieving means having openings of 0.8 to 3 mm, thereby providing three fractions; an upper fraction comprising grass fiber, an intermediate fraction comprising backing and a lower fraction comprising rubber, optionally the upper fraction is returned to the third downsizing means and further processed in the turf and backing separation section; in step vii) each of the intermediate fractions and the lower fraction are fed to a third set of two individual separating means, said means separating by specific gravity using air, to provide a second combined low-density fraction comprising turf material and a third combined high-density fraction comprising a rubber and backing mix.

By adding these separation steps, grass fiber and rubber—two of the most valuable components for reuse—are provided in substantially pure quality.

The fraction substantially comprising sand is separated in the second part of the infill separation section in order to provide, in particular, pure sand. Hence, the method may further comprise the steps of processing the second intermediate fraction obtained in step i) further for sand and rubber separation by the steps of:
viii) feeding the second intermediate fraction to a fourth sieving unit having four sieving means said sieving means having perforations in the range of 1.2 to 0.2 mm, where the size of the openings descends from top to bottom, to provide five fractions;
ix) feeding each of the five fractions to a fourth set of five individual separating means, said means separating by specific gravity using air, to provide a second set of low-density fractions comprising rubber, sand and/or fine fiber particles and a fourth combined high-density fraction comprising sand, wherein said fraction comprising sand is recovered.

Each of the second set of five low density fractions comprising rubber, sand and/or fine fiber particles are in step x) fed to a fifth set of five individual separating means, said means separating by specific gravity using air, to provide a low density fraction and a high density fraction as stipulated below.

When 30% vol/vol or more of the second set of low-density fractions is rubber, a third combined light fraction comprising rubber is provided, and a fourth combined heavy fraction comprising a mix of sand and rubber is provided, said heavy fraction is recycled to the fourth sieving unit in step viii); and when 30% vol/vol or less of the second set of low-density fractions is rubber, a fifth combined heavy fraction comprising sand is provided, and a fourth combined light fraction comprising a mix of rubber and sand is provided, wherein the sand is recovered, and the mix of rubber and sand may be further processed or discarded.

In the further step ix) sand is first recovered, and the next step is determined based on the presence of rubber in the fraction. In this way the process can flexibly be customized to compositions where the rubber is over or below 30% vol/vol. This has shown to result in the purest fraction of either sand or rubber. The remaining mix fraction may then either be discarded or can be further treated if the plant has capacity that is not utilised at a given point in time, such as in the infill after cleaning section.

This diverging of fractions is important since obtaining completely pure rubber is essential for being able to sell the fraction at a sustainable price.

The further processing and separation of the rubber may be performed by feeding one or more of the rubber fractions obtained throughput the process, such as the second combined high-density fraction obtained in step iv) and/or the third combined light fraction obtained in step x) when comprising rubber which is in embodiments where 30% vol/vol or more of the second set low-density fractions is rubber.

The fractions are further processed by the step of feeding one or more rubber fractions (14, 22) to a fifth sieving unit (212) having three sieving means, a first sieving means having openings of 1.5 to 4 mm, a second sieving means having openings of 0.7 to 1.5 mm, and a third sieving means having openings of 0.2 to 0.7 mm, thereby providing three distinct rubber fractions (29a to 29c) and a dust fraction (30)

In a variation of the above, the fifth sieving step may be preceded by feeding one or more of the rubber fractions to a unit capable of beating fine particles loose from the rubber particles, such as a hammer mill and feeding the thus beaten mixture to the fifth sieving unit.

In order to be able to run the entire process in a continuous manner at a certain speed, it may be desired to have buffer tanks at specific locations. Hence in an embodiment a buffer tank is in fluid communication with the unit capable of beating fine particles loose from the rubber particles, such as a hammer mill, is present, the buffer tank receives rubber fractions obtained throughout the process.

In order to increase the yield or minimize waste from the process, it is desirable to include an infill after cleaning section in the process and system. In the infill after cleaning section one or both of the heavy fraction comprising rubber, stone, and optionally sand which is obtained in step v) and the combined high density fraction obtained in step iii) are processed further the section comprises the steps of:
xii) feeding one or both of the heavy fraction comprising rubber, stone, and optionally sand and the combined high-density fraction, to a sieving step in a sixth sieving unit having two sieving means, a first sieving means having openings of 0.4 to 3 mm and a second sieving means having openings of 0.2 to 2 mm, thereby providing three fractions; an upper fraction, an intermediate fraction and a lower fraction;
vii) feeding each of the three fractions to a sixth set of three individual separating means, said means separating by specific gravity using air to provide a fifth combined low-density fraction comprising rubber and a sixth combined high-density fraction comprising stone and sand, and further wherein the rubber is recovered or further processed in the rubber polishing section, such as by feeding to the buffer tank or mixing with one or all of the second combined high-density fraction obtained in step iv) and/or the third combined light fraction obtained in step x) when comprising rubber which is in embodiments where 30% vol/vol or more of the second set low-density fractions is rubber. Hence, by adding this step, the yield of the rubber fraction is further increased, and the waste of the overall process reduced.

In parallel with the infill separation route, the feeding and downsizing section is also connected to the turf and backing separation section where the large fraction obtained in step f) in a step g) is downsized further to at most 35 mm in the largest dimension, and separated by specific gravity and size by providing an airflow directed upwards in a second separator configured to cause a swirling motion whereby a second lighter fraction is entrained upwards in the air flow and a second heavy fraction is allowed to fall downwards; where the second lighter fraction substantially comprises grass fiber components, and second heavy fraction substantially comprises a mixture of backing material and grass fiber component, in a further step h) the second lighter fraction substantially comprising grass fiber components is fed to a second screening unit, preferably a drum screen, having openings of 1 to 3 mm in the shortest dimension, to provide a final small fraction comprising backing and grass fiber waste and a final large fraction (35) comprising turf. The final large fraction comprising turf is in a step i) recovered and optionally further processing the turf in an after-processing section (500). The turf is the most valuable portion of the plastic fractions when reused.

According to all embodiments and steps, when using the separators configured to cause a swirling motion whereby the lighter fraction is entrained upwards in the air flow and the heavy fraction is allowed to fall downwards the unit is in preferred embodiments a cyclone separator or a zig-zag air sifter. When the separation is performed in a zig-zag air sifter the air is provided at a frequency of 18 to 27 Hz, more preferred 20 to 25 Hz. Tests were performed with various frequencies above and below the ranges above, and it was surprisingly found that the best separation was obtained within the ranges disclosed, and the best result was obtained at around 20 to 25 Hz.

The task of separating turf/grass fiber and backing becomes more and more difficult when the size of the mixed components becomes smaller and smaller. Thus, as the size becomes smaller the difference in weight of the individual components approximates. On the other hand, downsizing is a necessary means for being able to disintegrate the various components of the turf material. Therefore, downsizing at the specific points in the separation has turned out to be effective, since otherwise problematic components have substantially been separated off in the previous steps.

Also provided is a system for processing moist synthetic turf product in a continuous manner to provide individual components of synthetic turf product, said system comprising a feeding and a downsizing section an infill separation section and a turf and backing separation section, said feeding and downsizing section is in fluid communication with the infill separation section and the turf and backing separation section, wherein the feeding and downsizing section comprises an inlet for moist artificial turf product which is connected to downsizing unit such as a shredder, the outlet of the downsizing unit is connected to a drying unit, the outlet of the drying unit is connected to a first sieving unit which has two outlets, a first outlet which is connected to the infill separation section and a second outlet which is connected to a second downsizing unit capable of downsizing components to at most 50 mm in the largest dimension, the outlet of the second downsizing unit is connected to a material hopper, optionally through a first screening unit, such as a drum screen, having openings of 4 to 8 mm, preferably, 6 mm, said first screening unit has two outlets, a first outlet, a retentate, and a second outlet, a filtrate, where the first outlet is connected to the material hopper, which is continuously supplying the retentate fraction to a third downsizing unit, preferably a cutting mill. the outlet of the third downsizing unit is connected to the turf and backing separation section and the second outlet, the filtrate, is connected to the infill separation section.

The process and system according to the invention are configured for continuous processing of the three main sections, the feeding and downsizing, the infill separation section and the turf and backing separation section. The infill after cleaning section can be connected to the infill separation section as required by enabling the flow of various fractions as described above.

### BRIEF DESCRIPTION OF THE DRAWINGS

FIG. 1 is an illustration of the system and method of the invention.

FIG. 2 is an embodiment of the feeding and downsizing section of the invention.

FIG. 3 is an embodiment of the first part of the infill separation section of the invention.

FIG. 4 is an illustration of the second part of the infill separation section of the invention.

FIG. 5 is an illustration of the optional infill after cleaning section of the invention.

FIG. 6 is an illustration of the turf and backing separation section of the invention.

FIG. 7 is a partial perspective view of an embodiment of the grate like sieving means of the sieving units according to the invention.

FIGS. 7a and b show a detail of the embodiment of FIG. 7 and of a slightly different embodiment, respectively, of the grate like sieving means of the sieving units according to the invention.

FIG. 8 shows an embodiment of sieving means having wind breakers/baffles according to the invention.

### DETAILED DESCRIPTION

In the context of the present invention, essentially pure means that one component comprises more than 95% (w/w) of the fraction. Even more preferred more than 96% (w/w), more than 97% (w/w), more than 98% (w/w), more than 99% (w/w), or approximately 100%. In any event essentially pure means that the fraction in question is pure enough for reuse.

As used in the present invention, the term “a component” means one type of fraction of the starting product such as sand, rubber, polyethylene (PE), etc. The term should not be limited to the component originating from a specific part of the turf material/product but is rather defined by its type of chemical composition.

As used in the present invention, the term “synthetic/artificial turf product” contemplates all the components of the starting material used in the process of the invention. Synthetic and artificial may be used interchangeably and have the same meaning, namely a grass like product made of non-biological material.

The starting material for the process of invention is a turf product originating from a sports facility, a playground, a landscaping area, and the like. The origin of the material should not be limiting. It is also contemplated that the material may comprise contaminants. The starting material is moist. The moisture content varies from site to site. The invention should not be limited to a specific moisture content of the starting material.

The synthetic turf product usually comprises at least a backing material, infill and a turf/grass fiber component.

In the context of the present invention the term “backing material” contemplates one or more layers for holding the grass fiber component. Thus, the term backing material includes but is not limited to a material in which an artificial grass fiber is tufted, woven, or knitted, or otherwise attached to. The term backing material also contemplates a secondary backing or coating or, fastener parts for fastening pieces of turf products to each other or a surface.

In the context of the present invention the term “grass fiber component” or “turf” contemplates fibers or yarns, textured or non-textured, tufted, woven or knitted or otherwise attached to the backing material. The backing and grass fiber component may be made of the same or different materials.

In the context of the present invention the term “infill” contemplates rubber, sand and “additional components”.

In the context of the present invention the term “additional components” contemplates any material comprised in the turf product not comprised in the other terms. Thus, additional components may comprise, but are not limited to, waste caught in the turf carpet, dirt etc.

The synthetic turf product may also comprise a thatch or a “thatch zone” comprised of one or more thatching materials, preferably connected to the backing material such as by interweaving, gluing, melting, or any suitable means for attaching thatching materials to the backing material. Thatching of synthetic turf is well known in the art and is described in several documents such as U.S. Pat. No. 6,299,959 and WO 2004/042149. In the context of the present invention, if present, the material constituting the thatch, thatch zone and/or thatching is typically made of the same material as the grass fiber material and is then included in the term “grass fiber material”.

Typically, a synthetic turf product includes a fabric being a backing and a plurality of upstanding ribbons, also called face fibers or yarns, resembling grass, and in the context of the present invention face fibers or yarns are examples of grass fiber components according to the invention.

Typically, the grass fiber component is made of polyethylene, polypropylene or a blend thereof. The grass fiber may also be made of nylon or any other material known in the art alone or in combination with polypropylene and/or polyethylene.

These grass fiber components are usually tufted or sewn into a primary backing material which can be made of different materials including, but not limited to, polypropylene and polyester. It is primarily cost that drives the choice of material for the backing as being different from the i.a. the grass fiber.

A coating material may be applied to the grass fiber and primary backing to hold the grass like fibers in place.

The primary coating of most synthetic turf products includes polyurethane and also typically includes a coating filler such as calcium carbonate or coal fly ash. Primary coatings may also include latex, hot melt adhesives, and/or thermoplastics in addition to or instead of polyurethane.

Synthetic turf products may also have a secondary backing or coating which can be made of a number of different materials including, but not limited to, polypropylene and polyester.

The collected synthetic turf product including waste has the approximate composition: The grass fiber components typically make up from about 5 to 10 wt %, the backing typically makes up from about 5 to 10 wt %, the infill typically make up to 80 wt %.

In the contact of the present invention percentages is weight % unless stated otherwise.

The grass fiber components may include polyethylene, polypropylene, nylon, or other materials singly or in combination.

In some embodiments, the grass fibers include blends of polypropylene (PP) and polyethylene (PE). In further embodiments, the grass fibers include blends of PE or blends of PP, PE, and nylon.

The primary backing may include polyester, polypropylene, polyethylene and other materials singly, or in combination, such as polyethylene alone or blends of PP and polyester

The coating may include polyurethane, latex, hot melt adhesive, and/or thermoplastics alone or in combination. Suitable hot melt adhesives include, but are not limited to, Reynolds 54-041, Reynolds 54-854, DHM 4124 (The Reynolds Company P.O. Greenville, SC, DHM Adhesives, Inc. Calhoun, GA).

Suitable thermoplastics include, but are not limited to polypropylene, polyethylene and polyester. The coating may also include a coating filler that may be coal fly ash, calcium carbonate, iron oxide, or barium sulphate, or any other filler known in the art.

The synthetic turf product comprises an infill material dispersed among the upstanding ribbons of grass fiber, which contributes to the physical properties of the turf product making the turf suitable for a specific use.

Synthetic turf infill may be made of any material suitable for providing desired physical properties, the infill may be selected from but not limited to one or more of sand, gravel, cork, coco nut shells, polymer beads, and rubbers, including but not limited to crumb rubber, ethylene propylene diene monomer (EPDM) rubber, thermo plastic elastomers (TPE), and neoprene rubber alone, or in combination. Most often the infill is rubbers and sand. In a particular embodiment, the infill material is rubber or sand. In another particular embodiment the infill material is rubber and sand.

The invention described with the embodiment where the infill is sand and rubber. It is however, contemplated that the infill may be comprised of any of the above materials. Hence if composed of two other materials than sand and rubber, the material with the lowest density should replace rubber and material with the highest density should replace sand in the description and claims.

In preferred embodiments, the synthetic turf product further comprises one or more thatching materials connected to the backing material. Thatching material is typically made of the same material as the grass fiber component, polypropylene or nylon.

When an artificial turf field is removed from the site it is usually cut in pieces of 50 m×50 m and rolled. The rolls are transported to the site where they are to be further processed whether it being a landfill or a facility for recycling the product.

The thus parted turf field, the moist artificial turf product, is provided to the process of the invention in rolls typically having a diameter of 2 to 5 m and a width of 1 to 2 m. The size of the turf product when arriving at the processing facility can be any size, and the invention should not be limited by the size of the incoming turf. The size of the turf product is limited by practical handling alone.

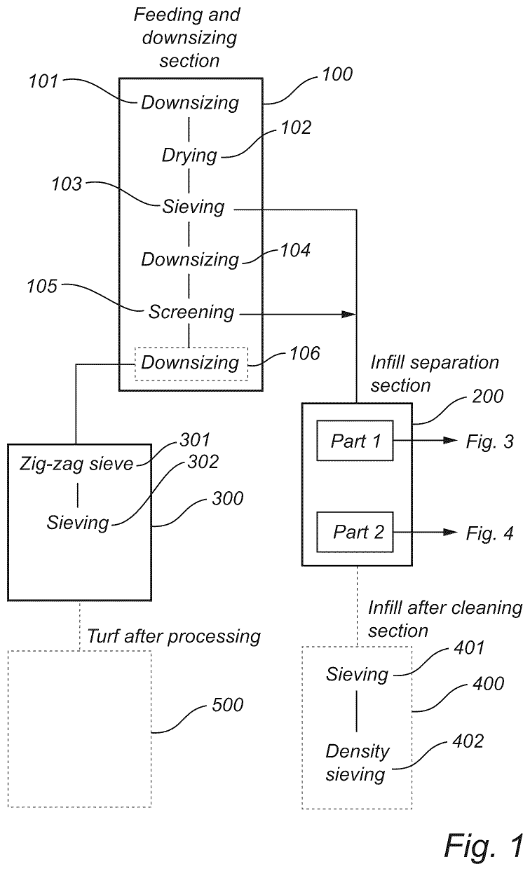

In the following, embodiments of the process will be described with reference to FIGS. 1 to 8. The invention should not be limited to the embodiments described below.

The process of the invention will now be described in further details with reference to FIG. 1 where the sections of the system and process are illustrated in their most general form.

The method and system comprise a feeding and downsizing section 100, an infill separation section 200 the infill separation section comprises two parts, and the method and system comprise a turf and backing separation section. Sections 100, 200 and 300 are connected as further detailed herein. Processing in section 100 may occur independent of sections 200 and 300 and processing in sections 100 and 200 may occur independent of section 100 and 300. The system further comprises an infill after cleaning section 400 following infill separation section 200 and a turf after processing section 500 following turf and backing separation section 300. However, the processing in the feeding and downsizing section is essential as a feed for the ability of the following sections to provide fractions at the yield and purity sought. The feeding and downsizing section 100, the infill separation section 200 and the turf and backing separation sections are designed such that the process and system can process material in a continuous manner. For this purpose, buffer tanks may be located to allow for feedback of certain fractions from a downstream part of the process to certain parts upstream. Hence the system and process are designed specifically for enabling such continuous processing in order to provide a cost-efficient process that is able to run throughout day and night if material is available. The after-cleaning sections 400 and 500 may be used as part of the continuous separation process or used to increase the yield of various intermediate fractions and run as batch processes. The nature of the turf after processing section 500 depends on a specific market or demand and can be any one of agglomeration, balling or extrusion.

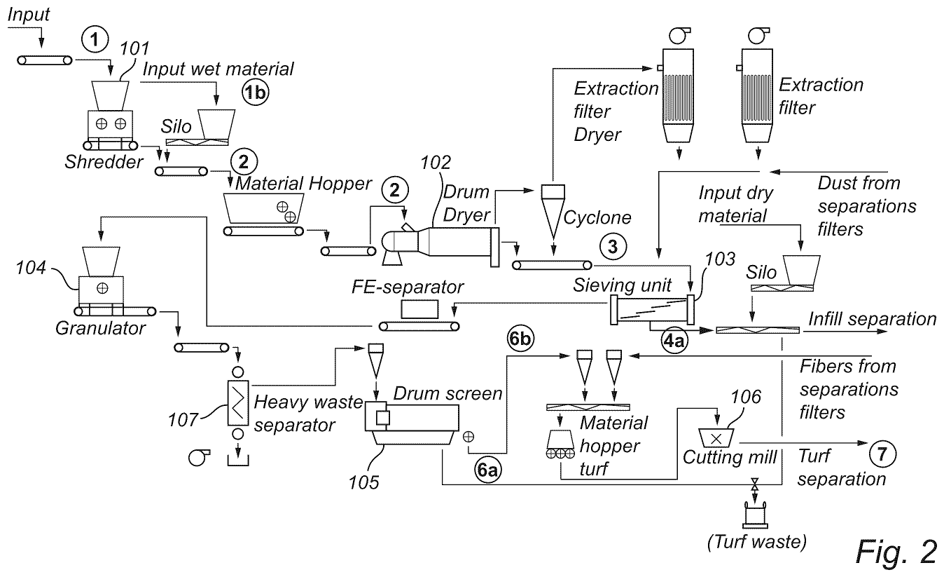

Further referring to FIG. 1, the feeding and downsizing section 100 generally comprises a first downsizing step/unit 101, a drying step/unit 102, a first sieving step/unit 103, a second downsizing step/unit 104, a first optional screening step/unit 105 and an optional third downsizing step 106. An embodiment of the feeding and downsizing section is shown in more details in FIG. 2.

The purpose of the feeding and downsizing section is to reduce the size of the artificial turf rolls to a manageable size that can be dried sufficiently to enable the subsequent sections of the process, the separations, without adversely affecting the polymers. This is a critical balance since the large amounts of sand present is capable of absorbing heat that can adversely affect the plastic and rubber. Also, the turf product has components of very different sizes and therefore it can be difficult to dry the various components sufficiently. Hence, the present invention solves the problem of the balancing act between size, type of material, time and temperature needed to be able to provide fractions to the subsequent sections that can be separated as desired.

The infill separation section 200 in the first part generally comprises a main screening sieving step/unit 201, a second sieving step/unit 202, a first density separation step/set of density units 203 (203_1 to 4), a second density step/set of density units 204 (204_1 to 4), a first step/means for separating by specific gravity and size 205 (such as a zig zag sieve), a third sieving step/unit 206 and a third density separation step/set of two density units 207 (207_1 and 2).

The infill separation section 200 in the second part generally comprises a fourth sieving step/unit 208, a third density step/set of five density units 209 (209_1-5), a fourth density separation step/set of five density units 210 (210_1-5), the second part may also include a step/means for shaking the rubber fraction 211, such as a hammer mill, and a fifth sieving step/unit 212.

In its broadest sense the system according to the invention comprises the feeding and downsizing section, 100, the infill separation section, 200 and the turf and backing separation section, 300, connected as illustrated in FIG. 1. In some embodiments, the system may also include an infill after cleaning section, 400 and/or a turf after processing section 500.

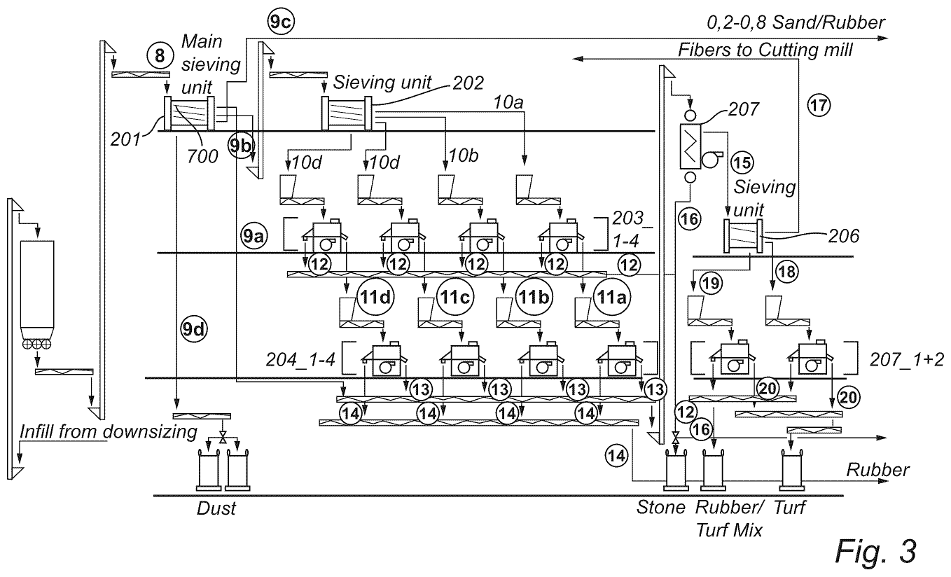

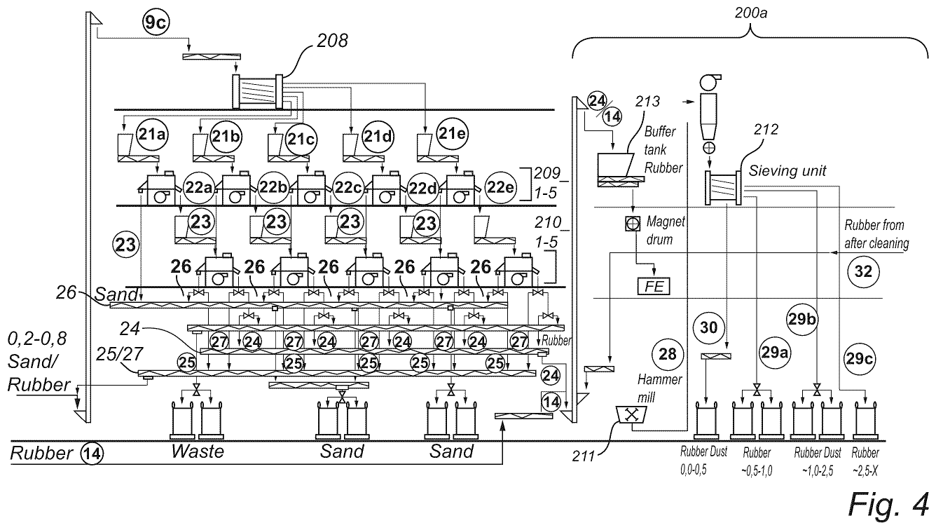

An embodiment of the infill separation section is shown in more details in FIGS. 3 and 4.

The purpose of part 1 of the infill separation section is to screen and separate stone from rubber, rubber from turf and backing from rubber. The focus is to provide clean rubber material as well as removing stones from the turf fiber material that is recycled to the third downsizing step/unit 106.

The second part of the infill separation step has two purposes. The first is to separate the rubber from the sand in order to provide clean sand and potentially increase the yield of rubber. The second purpose is to separate the clean rubber into distinct now upcycled sellable fractions, and to eliminate contamination with small particles that are unwanted in the final product, as there is no market for these.

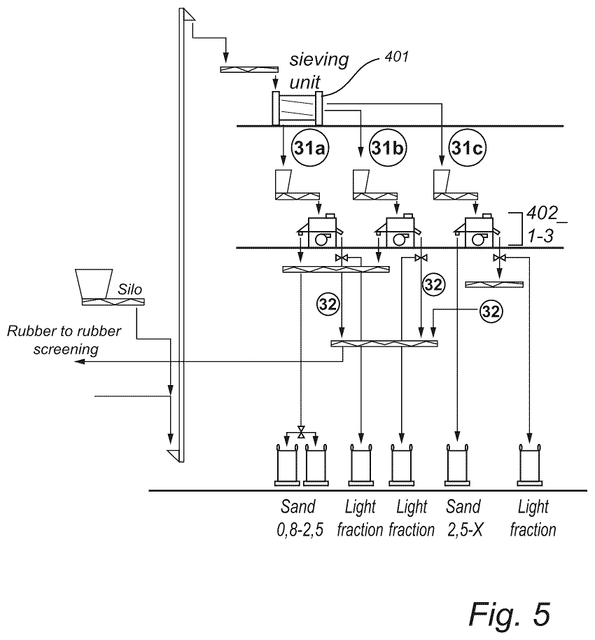

The turf and backing separation section 300 requires the third downsizing step 106 to be mandatory and generally comprises, a second step/means for separating by specific gravity and size 301 (such as a zig zag sieve) and a second screening step/unit 302. An embodiment of the turf and backing separation section is shown in more details in FIG. 5.

The purpose of the turf and backing separation section is to separate the turf and backing from each other, while removing any fine particles. This will provide fractions of distinct plastic types of different quality that can be upcycled for different purposes.

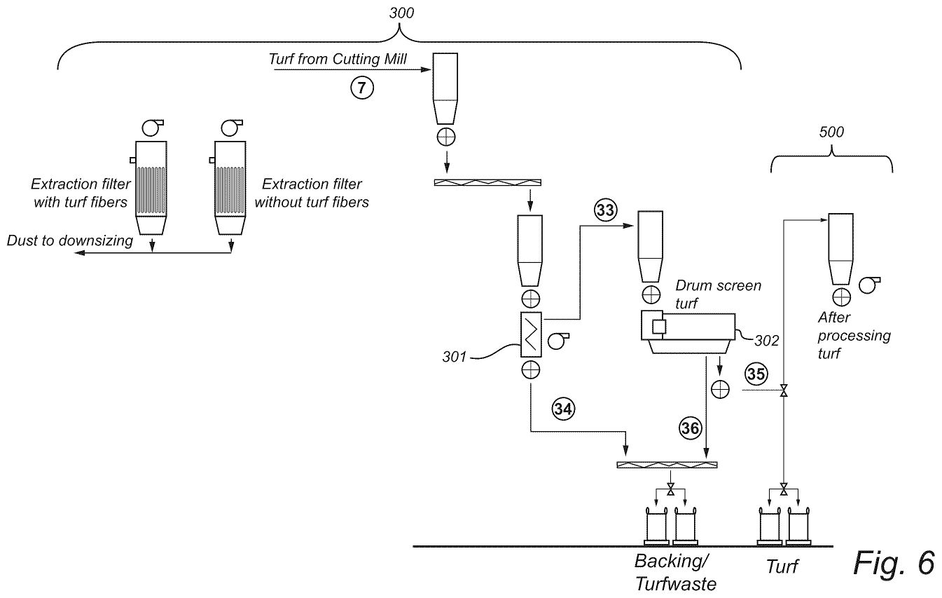

The infill after cleaning section 400 generally comprises a seventh sieving step/unit 401 and a fourth density separation step/set of density units 402 (402_1-3). An embodiment of the infill after cleaning section is shown in more details in FIG. 6.

The purpose of the infill after cleaning is to further extract valuable materials out of unfinished products, that would otherwise be non-separable. e.g., Rubber, stone and sand. Thus, the main purpose of this section is to increase the yield of the fractions.

The process will now be explained in even further details. It is understood that while FIGS. 2 to 6 will be described referring to a process, all descriptions equally apply to the system.

FIG. 2 is a detailed description of an embodiment of the feeding and downsizing section, 100.

In a first step, the artificial turf product, 1, is fed and downsized in a first downsizing step 101, which in the embodiment shown is a shredder, 101, downsizing the turf product to a size of approximately 120 by 120 mm. The downsized turf material, 2, is fed to a drying unit 102, which in the embodiment shown is a drum dryer 102. It is contemplated that further already downsized material may also be fed to the drum drier as illustrated as feed stream 1_b. A suitable means, such as a material hopper, is suitably used to ensure feeding of material at the volume and speed needed for operating the drying unit in the desired way.

For the best results the downsized turf material, 2, is fed at a speed of 6-10 tonnes per hour, preferably 8 tonnes per hour on a dry basis. The length of the drying unit, 102, is 8 to 15 meters, preferably 10 to 12 m. When the drying unit is a drum drier, it is operated at a speed of 1200 to 1500 rpm, preferably 1400 rpm. The temperature at the entry of the drying unit is in a range of 125 to 250° C., preferably 150 to 230° C.

The moisture content of the material after the drying step is at the most 5% w/w, preferably no more than 3% w/w and even more preferred no more than 1% w/w. Having such a low moisture content in all processes/units downstream from the drying unit is essential for being able to achieve a successful separation, in particular of sand and rubber.

The dried material, 3, is screened through a first sieving unit, 103, having openings of 5 mm, whereby two fractions are provided; a first fraction 4a substantially comprising infill material and a second fraction 4b substantially comprising a mixture of turf and backing material where the length of the largest dimension is at or above 5 to 7 mm, such as at or above 6 mm.

After this initial separation, the first and second fractions, 4a and 4b, are further processed independently.

The first fraction, 4a, substantially comprising infill is further processed in the infill separation section, 200, which will be explained in more detail with reference to FIGS. 3 and 4. It is contemplated that a silo, for adding additional dry infill to the first fraction 4a before feeding to the infill separation section, is present. Such material may come from downstream processes.

The second fraction, 4b, is in the embodiment shown further downsized, in this embodiment in a granulator, 104, to give smaller fractions, 5, where the size of the largest dimension is at most 50 mm. This step may be preceded by an iron removal step, whereby magnetic metal entrapped in the carpet is removed. The thus, further downsized fraction, 5 may optionally be subjected to a heavy waste separation step whereby heavy contaminants such as stones, may be removed from the carpet. Such step may be separation by specific gravity and size in a zig zag sieve or air sifter 107. The further downsized fraction, 5, is then screened in a first screening unit, 105, which is illustrated as a drum screen to provide a small fraction, 6a, comprising remaining infill and a large fraction 6b comprising turf and backing, which is fed to the turf and backing separation section 300. The small fraction 6a is fed to the infill separation section, optionally mixed with the first fraction 4a. The first screening unit is not mandatory, and it is contemplated that the further downsized fraction 5 may be fed directly to the turf and backing separation section or to a third downsizing step in a cutting mill 106 as described below.

The first screening means, the drum screen 105, has openings of 4-8 mm, preferably 6 mm. As illustrated in the embodiment, the large fraction 6b is fed to a material hopper which can ensure a continuous supply of turf and backing. It is also contemplated, as illustrated, that the large fraction is further downsized in a third downsizing step, which in the embodiment shown is a cutting mill, 106, in order to provide a turf and backing fraction, 7, of at most 35 mm in the largest dimension. It is contemplated that turf and backing fractions from downstream processes may be recycled and mixed with the large fraction 6b before the cutting mill, 106 as illustrated, this recycle however is optional and may be omitted.

In preferred embodiments the first screening step/unit is omitted.

With reference to FIG. 3 an embodiment of part one of the infill separation section according to the invention will now be described in further details.

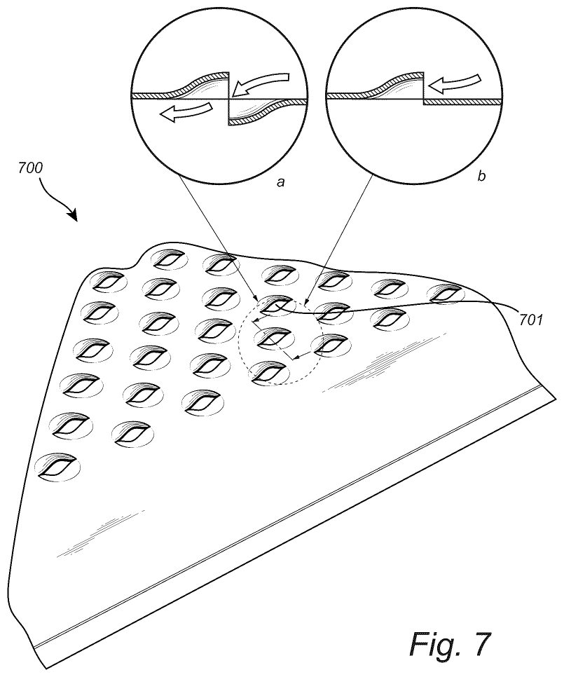

In the embodiment illustrated, the first fraction 4a and the small fraction 6a if present, optionally premixed, are in some embodiments as illustrated fed to a buffer tank (not shown) for holding infill in order to enable a continuous feed of streams through the entire process. From the optional buffer tank, the infill separation feed fraction 8 is fed to a main sieving unit, 201, having three sieving means 201_a-c. The first sieving means 201_a has perforations wherein the length of the longest dimension is 3 to 6 mm, the first sieving means is preferably a grate type sieving means which is further illustrated in FIGS. 7a and 7b. The second sieving means 201_b has openings of 0.5 to 1.5 mm and the third sieving means has perforations of 0.1 to 6 mm. Four main sieving fractions are provided (9a to d) a lower fraction 9d, a dust fraction, is collected. An upper fraction 9c is further processed for rubber, turf and backing separation. A second intermediate fraction 9b is further processed in the second part of the infill separation section as detailed with reference to FIG. 4. The first intermediate section 9b is further processed for rubber recovery also in the second part of the infill separation section, the rubber polishing part 200a.

The first sieving means of the main sieving unit is preferably provided with at least one baffle designed to ensure an even distribution of the material to be sieved over the whole are of the sieve. This is important in order to keep the speed of the continuous separation. Each sieving means is preferably provided with 1, 2, 3 or 4 baffles. Each baffle is positioned at an angle α, of 30 to 60°, preferably 40 to 50° even more preferred 45° relative to a horizontal plane of the sieving means framework.

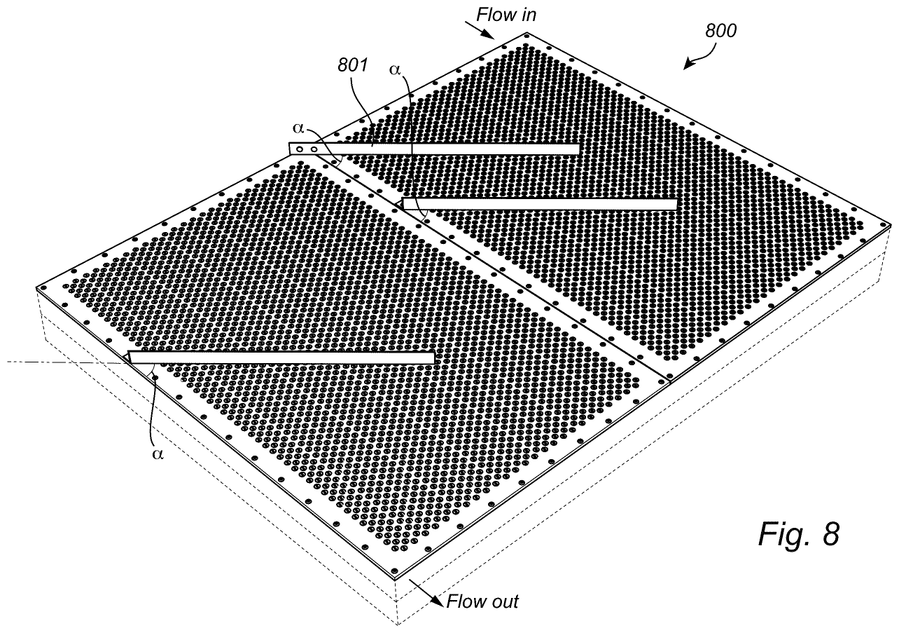

The one or more baffles are positioned in the middle section of the sieving means, preferably between ¼ and ¾ of the length of the sieving means. This is important since the natural flow of the infill, due to the slight inclination of the sieving means of around 5 to 10 degrees, will be to moved towards the edges of the sieving means in the middle section of sieving direction. Therefore, for optimal flow the baffles are positioned at horizontal planes in the middle 50% of the length of the sieving means. The length of the baffles is typically ¾ of the height of the sieving means and ½ of the breadth of the sieving means. The form and position of the baffles will be described in more detail in the below, with particular reference to FIG. 8.

It is also contemplated that further sieving means or all sieving means of the main and further sieving units are provided with such baffles.

The first intermediate section 9b is then fed to a second sieving unit 202 having three sieving means, a first sieving means having openings of 1.2 to 3.5 mm, a second sieving means having openings of 0.8 to 2.5 mm, and a third sieving means having openings of 0.5 to 2.0 mm, thereby providing four fraction 10 a to d. Each of the four fractions 10a to 10d are fed to a first set of four individual separating means 203_1-4, said means separating by specific gravity using air, to provide four low-density fractions 11a to 11d comprising backing material and rubber and a combined high-density fraction 12 comprising additional components, such as stones. Each of the four low density fractions 11a to 11d are fed to a second set of four individual separating means, 204_1 to 4 separating by specific gravity using air, to provide a combined low-density fraction 13 comprising backing material and a combined high-density fraction 14 comprising rubber, the combined high-density fraction 14 comprising rubber is recovered or further processed in a rubber polishing unit 200a, which will be described with reference to FIG. 4.

The combined low-density fraction 13 comprising backing material is separated by specific gravity and size by providing an airflow directed upwards in a separator, 205, configured to cause a swirling motion, in the embodiment shown it is a zig zag air sifter, 205. Here the lighter material 15 is entrained upwards in the air flow and the heavy material is allowed to fall downwards; the lighter fraction 15 comprises rubber, backing and turf material, and the heavy fraction 16 comprises additional material, such as stones and may be combined with high density fraction 12 as illustrated. The stones may either be sold as they are. If, however the stone fraction, 12+16, comprises rubber components, the fractions 12 and 16 will be fed to the infill after processing section, 400.

The lighter fraction, 15, comprising rubber, backing and turf material is sieved in a third sieving unit, 206, having two sieving means, a first sieving means having openings of 2 to 5 mm and a second sieving means having openings of 0.8 to 3 mm, thereby providing three fractions; an upper fraction 17 comprising grass fiber, an intermediate fraction 18 comprising backing and a lower fraction 19 comprising rubber. In the embodiment shown the upper fraction 17 is returned to the cutting mill 106 and further processed in the turf and backing separation unit 300. Each of the intermediate fraction 18 and the lower fraction 19 are fed to a third set of two individual separating means 207_1 and 207_2, said means separating by specific gravity using air, to provide a second combined low-density fraction 20 comprising turf material and a third combined high-density fraction comprising a rubber backing mix.

With reference to FIG. 4 an embodiment of part two of the infill separation section according to the invention will now be described in further details. The second intermediate fraction 9c obtained from sieving in the main sieving unit 201 is further processed for sand and rubber separation. The second intermediate fraction 9c is separated in a fourth sieving unit, 208, having four sieving means said sieving means having openings in the range of 1.2 or 0.8 to 0.2 mm where the size of the openings descends from top to bottom.

The specific choice of openings of the various sieving means in this and the other sieving units may be chosen using the method described in WO2021/048214 to the same applicant for optimal separation.

The sieving in sieving unit 208 provides five fractions 21a to 21e. Each of the five fractions 21a to 21e are fed to a fourth set of five individual separating means 209_1 to 5, said means separating by specific gravity using air, to provide a second set of low-density fractions 22a to 22e comprising rubber, sand and/or fine fiber particles and a fourth combined high-density fraction 23 comprising sand. The sand is collected and reused as appropriate. After the first separation of sand from the rubber and sand fraction, each of the five low density fractions 22a to 22e comprising rubber, sand and/or fine fiber particles are fed to a fifth set of five individual separating means 210_1 to 5, said means separating by specific gravity using air, to provide a second low density fraction and a second high density fraction.

According to the method the flow is directed such that when 30% vol/vol or more of the low-density fractions 22a to 22e is rubber, the density separation results in a third combined light fraction 24 comprising rubber which is sent to the rubber polishing unit 200a for further sorting optionally premixed with the rubber fraction, 14, as illustrated in the embodiment.

A fourth combined heavy fraction 25 comprising a mix of sand and rubber is also provided. This second heavy fraction 25 is recycled to the fourth sieving unit 208 as part of the particle flow.

On the other hand, when 30% vol/vol or less of the second set of low-density fractions 22a to 22e is rubber, a second heavy fraction 26 comprising sand is provided. This sand is collected and reused as appropriate suitably mixed with the fifth combined high-density fraction 23 comprising sand. In addition, a fourth combined light fraction, 27, comprising a mix of rubber and sand is provided. This mix of rubber and sand may be further processed, for example in the infill after cleaning unit, held in a buffer tank or discarded as appropriate to ensure the continuous flow of material.

The diversion of steams to the appropriate conveying means is achieved by having diverting means such as valves positioned at the outlets of the second set of density separation means. Suitable valves are standard switch valves either mechanically/electrically or manually operated.

In the rubber polishing part 200a of the infill separation section, rubber is separated in distinct sizes. The rubber fractions, 14 and 24, are in the embodiment shown fed to a unit capable of beating fine particles loose from the rubber particles, in the embodiment shown a hammer mill, 211. The effect of this step is to beat the fine particles loose of the rubber particles. Given the moisture content of the material the fine particles will be released from the rubber resulting in a beaten mixture 28 of rubber and floating fine sand particles. The beating step may be preceded by an iron removal unit. It is also preferable that an intermediate buffer tank 213 is positioned before the hammer mill, 211, to cater for the continuous processing of material. Hence, the buffer tank, when present, is in fluid communication with the unit capable of beating fine particles loose from the rubber particles 211, here a hammer mill, and the buffer tank receives rubber fractions obtained throughout the process, such as the rubber fractions 14 and 24 obtained upstream.

It is contemplated that both the buffer tank and unit capable of beating fine particles loose from the rubber particles are omitted. This is preferred for a simpler separation. In this embodiment the rubber feed is fed directly to a fifth sieving unit 212.

Thus, the optionally beaten rubber and fine sand particles mixture 28 is then fed to a fifth sieving unit 212 having three sieving means, a first sieving means having openings of 1.5 to 4 mm, a second sieving means having openings of 0.7 to 1.5 mm, and a third sieving means having openings of 0.2 to 0.7 mm, thereby providing three distinct rubber fraction 29a to 29c are provided which are collected and reused as appropriate. Further a dust fraction 30 is provided.

When one or more of the fractions 12 and 16 comprise rubber, the fractions, optionally combined, are further treated for recovering stone and rubber for further end use. This processing takes place in the infill after processing section 400. This section is not always part of the continuous flow but can be included if and when there is a need for further separation of stone and rubber. In down time, the section may be used to separate fractions in various so-called waste fractions generated throughout the process, in order to increase the yield, thus minimizing the total waste of the process.

In the embodiment shown the combined high-density fraction 12 and the heavy fraction 16 are fed to a sixth sieving unit 401 having two sieving means, a first sieving means having openings of 0.4 to 3 mm and a second sieving means having openings of 0.2 to 2 mm, thereby providing three fractions 31a to 31c; an upper fraction 31a, an intermediate fraction 31b and a lower fraction 31c. Each of the three fractions 31a to 31c are fed to a sixth set of three individual separating means 402_1 to 4023, said means separating by specific gravity using air, to provide a fifth combined low-density fraction 32 comprising rubber and a sixth combined high-density fraction 33 comprising stone and sand. The rubber fraction 32 is recovered or further processed in the rubber polishing section 200a.

The turf and backing is separated in the turf and backing separation section 300, the separation is achieved by feeding the large fraction 7 obtained in the feeding and downsizing section, downsized further to at most 35 mm in the largest dimension, the thus downsized fraction is separated by specific gravity and size by providing an airflow directed upwards in a second separator 301 configured to cause a swirling motion whereby a second lighter fraction 33 is entrained upwards in the air flow and a second heavy fraction is allowed to fall downwards; where the second lighter fraction 33 substantially comprises grass fiber components, and the second heavy fraction 34 substantially comprises a mixture of backing material and grass fiber component. Then the grass fiber, which is the plastic of highest upcycle quality is further enriched by feeding the second lighter fraction 33 substantially comprising grass fiber components to a second screening unit 302, preferably a drum screen, having openings of 1 to 3 mm in the shortest dimension, to provide a final small fraction comprising 36 backing and grass fiber waste and a final large fraction comprising turf. The final large fraction 35 comprising turf is recovered or may further processed in an after-processing section 500.

The openings of the second screening unit are in preferred embodiments elongated. This will further enrich and purify the larger grass fiber fractions.

In all the descriptions above where a separator is configured to cause a swirling motion whereby the lighter fraction is entrained upwards in the air flow and the heavy fraction is allowed to fall downwards it is preferred that the unit is a cyclone separator or a zig-zag air sifter, and wherein when the separation is performed in a zig-zag air sifter the air is provided at a frequency of 18 to 27 Hz, more preferred 20 to 25 Hz.

Two embodiments of the grate like sieving means 700 are illustrated further in FIG. 7 and enhanced views FIGS. 7a and 7b. Referring first to FIGS. 7 and 7a, it is seen that a grating slot is formed between two sections at each perforation 701 of the grate like sieving means 700, in that a lower section of the perforation in FIG. 7a protrudes downwards relative to a general plane defined by the grate like sieving means and an upward section protrudes upwards to the general plane such that the grating slot formed at each perforation 701 is symmetrical around an axis lying in the general plane of the grate like sieving means 700. In the other embodiment, shown in FIG. 7b, the upward section is formed in substantially the same manner as in the embodiment of FIGS. 7 and 7a; however, the lower section extends substantially in the general plane of the grate like sieving means 700.

The positioning of the grate like sieving means 700 within the system is indicated in FIG. 3, in which one grate like sieving means 700 of a stack of sieving means is shown in the main sieving unit 201. The slight inclination of the grate like sieving means 700 is also indicated in FIG. 3.

The configuration of the individual sieving means of the various sieving units of the system may be selected as described.

While the sieving means have been referred to as grate like sieving means 700, having for instance features as described in the above and shown in FIGS. 7, 7a and 7b, other configurations of the sieving means are conceivable.

One example of such a general sieving means 800 is shown in FIG. 8, in which also the form and position of the above-mentioned baffles, here indicated as three baffles 801, are shown. In the embodiment shown, the angle α formed between each baffle 801 and a respective line in the horizontal plane of the sieving means 800 is around 45°.

Also indicated in FIG. 8 is the formation of a stack of sieving means, shown in dashed lines below the sieving means 800. As in the embodiments described in the above, the sieving means 800 may be positioned with a slight inclination in the flow direction. The inclination may vary between the sieving means of the various the sieving units, just as the inclination may be selected individually for the sieving means of a stack in a sieving unit.

In a second aspect a system for separating synthetic or artificial turf product is provided, the system is configured as detailed in the process above. In its most general sense, the system is for processing moist synthetic turf product in a continuous manner to provide individual components of synthetic turf product, said system comprising a feeding and a downsizing section (100) an infill separation section (200) and a turf and backing separation section (300), said feeding and downsizing section (100) is in fluid communication with the infill separation section (200) and the turf and backing separation section (300), wherein the feeding and downsizing section (100) comprises an inlet for moist artificial turf product (1) which is connected to downsizing unit (101) such as a shredder, the outlet of the downsizing unit (101) is connected to a a drying unit (102), the outlet of the drying unit is connected to a first sieving unit (103) which has two outlets, a first outlet which is connected to the infill separation section (200) and a second outlet which is connected to a second downsizing unit (104) capable of downsizing components to at most 50 mm in the largest dimension, the outlet of the second downsizing unit (104) is connected to a first screening unit (105), such as a drum screen having openings of 4 to 8 mm, preferably, 6 mm, said first screening unit has two outlets, a first outlet a retentate and a second outlet a filtrate, where the first outlet is connected to a material hopper continuously supplying the retentate fraction to a third downsizing unit (106), preferably a cutting mill, the outlet of the third downsizing unit (106) is connected to the turf and backing separation section (300) and the second outlet the filtrate is connected to the infill separation section (200).

All embodiments and variations described with reference to the process equally apply to the system and vice versa.

Key to the process and system is the order of separation steps and in further embodiments the parameters of the separation steps. Different orders of separation, combination of units and parameters resulted in an inferior end product, i.e., fractions comprising substantial amounts of other constituents and/or contaminants, which makes the fraction less usable as a high grade recycling product.

Hence, the invention also provides recycled components of an artificial turf product and more specifically recycled sand, recycled rubber, recycled grass fiber components and recycled backing material obtained or obtainable by the process according to the invention.

The components are characterized by a purity of more than 95% (w/w) of the fraction. Even more preferred more than 96% (w/w), more than 97% (w/w), more than 98% (w/w), more than 99% (w/w), or approximately 100% of the fraction.

Turf products often comprise components of different colours, hence the resulting fractions may be evaluated visually for assessment of purity. Purity of e.g. rubber and grass fiber may be evaluated using standard tests in the art such as D5603 and E1131-08 from ASTM International for testing the purity of the rubber and plastics. In addition, the purity may be determined by manually or mechanically separating portions of the components and determine the weight—% and extrapolate.

The products or fractions obtained by the process of the invention are useful as starting materials in a number of industries such as but not limited to rubber molding industry, construction industry, the synthetic turf industry and the plastic extrusion industry.

Therefore, in another aspect the invention can be seen as a process for providing a starting material in the manufacture of rubber tiles, rubber mats, rubber flooring, plastic pellets, and plastic boxes; wherein the process comprises the steps and variations as outlined above as well as the products obtained by any of the above. Hence another aspect of the invention is the use of a fraction selected from one or more of sand, rubber, grass fiber component and backing material each fraction separately obtained by the process of the invention in any of the industries mentioned above.

The separator operating by separating by specific gravity and size by providing an airflow directed upwards configured to cause a swirling motion may be any suitable means in the art such as a cyclone separator, e.g. Hovex De-Sanding Cyclone from Gea AG, a zigzag air sifter, e.g. ZZS Air sifter from Trenn-und Sortiertechnik GmbH, or similar separating means

The zig zag sieve may be an air sifter type ZZS180/800 obtainable from Trenn-und Sortiertechnik GmbH in which the swirling motion is caused by injecting an air flow, a, into zig zag channels within the sorting channel. The air is provided at a frequency of 25 Hz. Other suppliers of zig zag sieves are available such as Hamos GmbH, Penzberg, Germany. In the test below, the zig zag sieve/air sifter separator was a ZZS air sifter obtainable from Trenn-und Sortiertechnik GmbH in which the swirling motion is caused by zig zag channels within the sorting channel, hence the name.

Suitable separation means usable for separating by specific gravity (density separation) are obtainable from Trenn-und Sortiertechnik GmbH or Guidetti S.r.l., Renazzo, Italy.

Suitable sieving units according to the invention are TTS Separating Tables No. TTSS900/1000/1 and TTS600/1000/1 obtainable from Trenn-und Sortiertechnik GmbH.

A suitable downsizing means is a cutting mill of the type H500/R2-2000, available from Hosokawa Alpine AG, but may be obtained from other suppliers such as Amis Maschinen Vertriebs GmbH, Zuzenhausen, Germany.

Suitable shredders and drum screens are components generally known in the art, the choice of specific units are within the skill of the art. The specific shredder used for the tests was a model H500/R2-2000 obtainable from Erdwich Zerkleinerungs-Systeme GmbH.

It is also contemplated that magnets are inserted at various point of the process for removing magnetic components or contaminants, and preferably, the magnets are positioned before the various cutting steps in order to avoid destruction of the blades.

It is to be understood that the process and system of the invention also includes necessary means for transporting, feeding, holding, directing, opening and closing fractions etc. some of these but not all are illustrated in the drawings but the invention should not be limited to these specific units or locations unless otherwise stated. These are standard means known in the art.

The method and system according to the invention can process around 8 tonnes/hour to 192 tonnes/hour, 24 hours a day.

### EXAMPLES

In the following an embodiment of the invention will be illustrated in terms of fraction recovery and reduction of waste compared to a prior art process. The test followed the process of sections 100, 200, and 300 but the weight processed was slightly smaller than a full size field, specifically the processes were stopped after collecting 100 tonnes and then extrapolated up to the expected tonnage of a full batch of 155 tonnes as indicated in the tables below. Hence, the results are extrapolated but in order to have the same amount of material it is not practical to run full batches for the purpose of comparing.

Prior to running the selected portion of the test field, all equipment was emptied, to ensure that only material from the selected field in the separation process was included. All big bags containing the various fractions were weighed and data gathered, and the distribution of all fractions was calculated.

The tables compare a commercially running facility with the extrapolated result from a test facility when using the method of the invention.

TABLE 1
Output from a prior art process

| Fraction | Tonnage | % |
|---|---|---|
| SBR 1.0-2.5 MM | 45.61 | 29.33% |
| SAND 0.5-0.8 MM | 31.48 | 20.24% |
| SAND 0.2-0.5 MM | 30.92 | 19.89% |
| BACKING | 10.88 | 7.00% |
| SAND/RUBBER MIX | 8.76 | 5.64% |
| STONE 2 | 8.89 | 5.72% |
| RUBBER/TURF/BACKING | 4.42 | 2.84% |
| MIX | | |
| TURF PE | 5.34 | 3.43% |
| TURF DUST | 3.51 | 2.26% |
| FILTER DUST | 2.22 | 1.43% |
| SEPARATION DUST | 2.82 | 1.82% |
| FILTER DUST ERDWICH | 0.00 | 0.00% |
| HEAVY FRACTION | 0.39 | 0.25% |
| WASTE | | |
| SBR 0.5-1.0 MM | 0.26 | 0.17% |
| Total | 155.50 | 100.00% |
| Mix/Waste | 22.07 | 14.19% |

TABLE 2
Extrapolated data from test site

| Fraction | Tonnage | % |
|---|---|---|
| SBR 1.0-2.5 MM | 49.37 | 31.75% |
| SAND 0.5-0.8 MM | 35.58 | 22.88% |
| SAND 0.2-0.5 MM | 34.95 | 22.48% |
| BACKING | 10.88 | 7.00% |
| STONE 1 | 8.73 | 5.62% |
| TURF PE | 5.34 | 3.43% |
| TURF DUST | 3.51 | 2.26% |
| SEPARATION DUST | 2.82 | 1.82% |
| FILTER DUST | 2.22 | 1.43% |
| RUBBER/TURF/BACKING | 0.65 | 0.42% |
| MIX | | |
| HEAVY FRACTION | 0.39 | 0.25% |
| WASTE | | |
| SBR 0.5-1.0 MM | 0.26 | 0.17% |
| STONE 2 | 0.16 | 0.10% |
| SAND/RUBBER MIX | 0.63 | 0.40% |
| FILTER DUST | 0.00 | 0.00% |
| Total | 155.50 | 100.00% |
| Mix/Waste | 1.44 | 0.92% |

As can be seen the amount of non-separated fractions that are otherwise discarded (the fractions in bold) are reduced by 13.27%-points, in the given example corresponding to 20.63 tonnes of less waste.

Given the large volumes, the method of the invention proves a surprising advantage over the existing processes whereby the purity has remained at the desired and required high levels while the throughput and yield has increased.

This is an important improvement in the important quest in providing economically feasible solutions to the global waste management challenge.

A further advantage of the present invention is the ability to separate rubber infill of different densities. This is a significant improvement over prior art processes since the reuse of mixed density rubber has proven less useful.

In terms of economy of scale, the process of the invention results in a 50% more profitable business case as illustrated below.

TABLE 3

| | Prior art process | | Process according to the invention | |
|---|---|---|---|---|
| | | Estimated | | Estimated |
| | | price/disposal | | price/disposal |
| | tonnes | cost (Euro) | Tonnes | cost |
| Sellable | 113.60 | 6,369 | 134.24 | 7,083 |
| Waste | 19.82 | −752 | 19.82 | −752 |
| Mix | 22.04 | −1,536 | 1.44 | −95 |
| Total | 155.50 | 4,081 | 155.50 | 6,235 |
| Difference | | | | +2,155 |

In addition, pure fractions were obtained. As an example, below the various sand fractions were analysed for purity. Remaining fractions are analysed for purity according to standard listed methods as detailed above. The obtained purity of these fractions was on a similar level and as described also in the detailed description.

The purity of the sand was determined by subjecting a weighed sample to an incineration step according to standard ash test methods whereby the material is heated for typically 2 hours at above 500° C., whereby all organic material will degrade whereafter the sample is weighed again. The purity is calculated based on the difference in weight.

The fractions analysed were fractions 23 (table 4) and 26 (table 5) illustrated in FIG. 4.

TABLE 4
Composition of inorganic/organic

| | Weight in grams (g.) | | | | |
|---|---|---|---|---|---|
| | | Cup w. | Cup w. | | |
| | only | sample | sample | % | % |
| | 35 mm | before | after | inorganic | organic |
| Fraction size | cup | burning | burning | material | material |
| 0.2-0.5 | 29.1348 | 37.8844 | 37.8319 | 99.40% | 0.60% |
| 0.5-0.8 | 32.5705 | 41.0611 | 41.0281 | 99.61% | 0.39% |

TABLE 5
Composition of inorganic/organic material

| | Weight in grams (g.) | | | | |
|---|---|---|---|---|---|
| | | Cup w. | Cup w. | | |
| | only | sample | sample | % | % |
| Fraction | 35 mm | before | after | inorganic | organic |
| size | cup | burning | burning | material | material |
| 0.2-0.4 | 29.5972 | 35.9923 | 35.9312 | 99.04% | 0.96% |
| 0.4-0.5 | 27.1697 | 33.2874 | 33.2587 | 99.53% | 0.47% |
| 0.5-0.6 | 29.1345 | 36.1635 | 36.1333 | 99.57% | 0.43% |
| 0.6-0.7 | 31.6005 | 37.7049 | 37.6844 | 99.66% | 0.34% |
| 0.7-0.8 | 26.8594 | 33.7688 | 33.7381 | 99.56% | 0.44% |

From the results, it can be seen that the purity of almost all the various sand fractions exceeds 99.50%.

Thus, in addition to a high yield a high purity is also achieved according to the invention.

Non-incinerated samples may be further analysed for dirt quality to determine the chemical composition of the contaminants to be able to classify the sand/dirt for the end use.

What is claimed is:

1-17. (canceled)

18. A method for processing a synthetic turf product and for re-covering components thereof, said method comprising a feeding and a downsizing section an infill separation section and a turf and backing separation section, said feeding and downsizing section is in fluid communication with the infill separation section and the turf and backing separation section, and
wherein the feeding and downsizing section comprises the following steps:
(a) feeding a moist artificial turf product to the feeding and downsizing section,
(b) downsizing the moist artificial synthetic turf product into a downsized turf material, preferably to no more than 120 by 120 mm, and feeding the downsized turf material to a drying unit,
(c) drying the downsized turf material in the drying unit to a moisture content of no more than 5% w/w,
(d) separating the dried material by screening in a first sieving unit into at least a first fraction substantially comprising an infill material which is fed to the infill separation section and a second fraction substantially comprising grass fiber and backing components,
(e) downsizing the second fraction substantially comprising grass fiber and backing components to at most 50 mm in the largest dimension in a downsizing unit and optionally feeding the further downsized fraction to a first screening unit, such as a drum screen having openings of 4 to 8 mm to provide a small fraction and a large fraction,
(f) feeding the further downsized fraction or if present, the large fraction, obtained in step (e) to a material hopper continuously supplying the fraction, optionally downsized further to at most 35 mm in the largest dimension, to the turf and backing separation section; and
(g) further processing the first fraction obtained in step (d) and the small fraction, if present, obtained in step (e) in the infill separation section.

19. The method according to claim 18, wherein the drying the downsized turf material in the drying unit is to a moisture content of no more than 3% w/w.

20. The method according to claim 18, wherein the drying the downsized turf material in the drying unit is to a moisture content of no more than 1% w/w.

21. The method according to claim 18, wherein the drying unit is a drum drier.

22. The method according to claim 18, wherein the drum screen has openings of 6 mm.

23. The method according to claim 18, wherein in the drying of step (c) drying air temperature at the entry of the drying unit has a temperature in the range of 125 to 250° C., a length of the drying unit is 8 to 15 m, and the downsized turf material is fed at a range of 6 to 10 tonnes per hour, on a dry basis.

24. The method of claim 23, wherein the temperature range is 150 to 230° C.

25. The method of claim 23, wherein the length of the drying unit is 10 to 12 m

26. The method of claim 23, wherein the downsized turf material is fed at 8 tonnes/hour.

27. The method according to claim 18, wherein the drying unit is a drum dryer operated at a speed of 1200 to 1600 rpm.

28. The method of claim 27, wherein the drum dryer operated at a speed of 1400 rpm.

29. The method according to claim 18, wherein the infill separation section comprises the following steps
i) feeding the first fraction obtained in step d) and the small fraction obtained in step e) to a main sieving unit having three sieving means, a first sieving means, a second sieving means having openings of 0.5 to 1.5 mm, and a third sieving means having openings of 0.1 to 6 mm, wherein the first sieving means is a grate type sieving means having perforations wherein the longest dimension of the perforations is 3 to 6 mm, thereby providing four fractions, an upper fraction, a first and second intermediate fraction and a lower fraction, wherein the first intermediate fraction is further processed for rubber recovery and the second intermediate fraction is further processed for sand recovery.

30. The method according to claim 29, wherein one or more of the sieving means is provided with at least one baffle, preferably on the first sieving means.

31. The method according to claim 22, wherein the at least one baffle is positioned at an angle in the range of 30 to 60°, in relation to a horizontal plane of the sieving means, and wherein the at least one baffle is attached in the middle section of the sieving means, preferably on a horizontal line between ¼ and ¾ of the length of the sieving means.

32. The method of claim 31, wherein the angle in the range of 40 to 50°.

33. The method of claim 31, wherein the angle is 45°.

34. The method according to claim 30, wherein each sieving means has two or more baffles.

35. The method of claim 30, wherein each of the sieving means has 2, 3, 4 or 5 baffles.

36. The method according to claim 29, wherein the first intermediate fraction is further processed for rubber recovery by the steps of
ii) feeding the first intermediate fraction to a second sieving unit having three sieving means, a first sieving means having openings of 1.2 to 3.5 mm, a second sieving means having openings of 0.8 to 2.5 mm, and a third sieving means having openings of 0.5 to 2.0 mm, thereby providing four fractions;
iii) feeding each of the four fractions obtained from the second sieving unit to a first set of four individual separating means, said means separating by specific gravity using air, to provide four low-density fractions comprising backing material and rubber and a combined high-density fraction comprising additional components, such as stones;
iv) feeding each of the four low density fractions to a second set of four individual separating means, said means separating by specific gravity using air, to provide a combined low-density fraction comprising backing material and a second combined high-density fraction comprising rubber, and further wherein the second combined high-density fraction comprising rubber is recovered or further processed in a rubber polishing unit.

37. The method according to claim 36, wherein the combined low-density fraction comprising backing material is further subjected to the steps of
v) separating by specific gravity and size by providing an airflow directed upwards in a separator configured to cause a swirling motion whereby a lighter fraction is entrained upwards in the air flow and a heavy fraction is allowed to fall downwards; where the lighter fraction comprises backing material, and the heavy fraction comprises additional material, such as stones,
vi) subjecting the lighter fraction comprising backing material to a third sieving step in a third sieving unit having two sieving means, a first sieving means having openings of 2 to 5 mm and a second sieving means having openings of 0.8 to 3 mm, thereby providing three fractions; an upper fraction comprising grass fiber, an intermediate fraction comprising backing and a lower fraction comprising rubber, optionally the upper fraction is returned to the third downsizing means and further processed in the turf and backing separation section;
vii) feeding each of the intermediate fraction and the lower fraction to a third set of two individual separating means, said means separating by specific gravity using air, to provide a second combined low-density fraction comprising turf material and a third combined high density fraction comprising a rubber and backing mix.

38. The method according to claim 29, wherein the second intermediate fraction obtained in step i) is further processed for sand and rubber separation by the steps of:
viii) feeding the second intermediate fraction to a fourth sieving unit having four sieving means said sieving means having perforations in the range of 1.2 to 0.2 mm, where the size of the openings descends from top to bottom, to provide five fractions;
ix) feeding each of the five fractions to a fourth set of five individual separating means, said means separating by specific gravity using air, to provide a second set of low-density fractions comprising rubber, sand and/or fine fiber particles and a fourth combined high-density fraction comprising sand, wherein said fraction comprising sand is recovered;
x) feeding each of the second set of five low density fractions comprising rubber, sand and/or fine fiber particles to a fifth set of five individual separating means, said means separating by specific gravity using air, to provide a low density fraction and a high density fraction; wherein when 30% vol/vol or more of the second set of low-density fractions is rubber, a third combined light fraction comprising rubber is provided, and a fourth combined heavy fraction comprising a mix of sand and rubber is provided, said heavy fraction is recycled to the fourth sieving unit in step viii); and,
wherein when 30% vol/vol or less of the second set of low-density fractions is rubber, a fifth combined heavy fraction comprising sand is provided, and a fourth combined light fraction comprising a mix of rubber and sand is provided, wherein the sand is recovered and the mix of rubber and sand may be further processed or discarded.

39. The method according to claim 29, wherein any one of the rubber fractions are further processed by the step of
feeding one or more rubber fractions to a fifth sieving unit having three sieving means, a first sieving means having openings of 1.5 to 4 mm, a second sieving means having openings of 0.7 to 1.5 mm, and a third sieving means having openings of 0.2 to 0.7 mm, thereby providing three distinct rubber fractions and a dust fraction.

40. A method according to claim 39, wherein the fifth sieving step is preceded by feeding one or more of the rubber fractions to a unit capable of beating fine particles loose from the rubber particles, such as a hammer mill and feeding the thus beaten mixture to the fifth sieving unit.

41. The method according to claim 39, wherein a buffer tank is in fluid communication with the unit capable of beating fine particles loose from the rubber particles, such as a hammer mill, and wherein the buffer tank is fed with rubber fractions obtained according to anyone of the previous claims.

42. The method according to claim 37, wherein one or both of the heavy fraction comprising rubber, stone, and optionally sand and the combined high density fraction is processed further in an infill after cleaning section, said section comprising the steps of:
xii) feeding one or both of the heavy fraction comprising rubber, stone, and optionally sand and the combined high-density fraction, to a sieving step in a sixth sieving unit having two sieving means, a first sieving means having openings of 0.4 to 3 mm and a second sieving means having openings of 0.2 to 2 mm, thereby providing three fractions; an upper fraction, an intermediate fraction and a lower fraction;
vii) feeding each of the three fractions to a sixth set of three individual separating means, said means separating by specific gravity using air to provide a fifth combined low-density fraction comprising rubber and a sixth combined high-density fraction comprising stone and sand, and further wherein the rubber is recovered or further processed in the rubber polishing section.

43. The method according to claim 18, wherein the turf and backing separation section comprises the steps of
g) separating the large fraction obtained in step f) downsized further to at most 35 mm in the largest dimension, by specific gravity and size by providing an airflow directed upwards in a second separator configured to cause a swirling motion whereby a second lighter fraction is entrained upwards in the air flow and a second heavy fraction is allowed to fall downwards; where the second lighter fraction substantially comprises grass fiber components, and second heavy fraction substantially comprises a mixture of backing material and grass fiber component, h) feeding the second lighter fraction substantially comprising grass fiber components to a second screening unit, preferably a drum screen, having openings of 1 to 3 mm in the shortest dimension, to provide a final small fraction comprising backing and grass fiber waste and a final large fraction comprising turf, and
i) recovering the final large fraction comprising turf and option-ally further processing the turf in an after-processing section.

44. A method according to claim 37, wherein the separators configured to cause a swirling motion whereby the lighter fraction is entrained upwards in the air flow and the heavy fraction is allowed to fall downwards is a cyclone separator or a zig-zag air sifter, and wherein when the separation is performed in a zig-zag air sifter the air is provided at a frequency of 18 to 27 Hz.

45. The method according to claim 44, wherein the air is provided at a frequency of 20 to 25 Hz.

46. A system for processing moist synthetic turf product in a continuous manner to provide individual components of synthetic turf product, said system comprising a feeding and a downsizing section an infill separation section and a turf and backing separation section, said feeding and downsizing section is in fluid communication with the infill separation section and the turf and backing separation section, wherein
the feeding and downsizing section comprises an inlet for moist artificial turf product which is connected to downsizing unit such as a shredder, the outlet of the downsizing unit is connected to a drying unit, the outlet of the drying unit is connected to a first sieving unit which has two outlets, a first outlet which is connected to the infill separation section and a second outlet which is connected to a second downsizing unit capable of downsizing components to at most 50 mm in the largest dimension, the outlet of the second downsizing unit is connected to a material hopper, optionally through a first screening unit, having openings of 4 to 8 mm, said first screening unit has two outlets, a first outlet, a retentate, and a second outlet, a filtrate, where the first outlet is connected to the material hopper, which is continuously supplying the retentate fraction to a third downsizing unit, preferably a cutting mill. the outlet of the third downsizing unit is connected to the turf and backing separation section and the second outlet, the filtrate, is connected to the infill separation section.

47. The system according to claim 46, wherein the openings are 6 mm.

48. The system according to claim 46, wherein the first screening unit is a drum screen.
